(19) United States
(12) Patent Application Publication
(10) Pub. No.: US 2015/0153289 A1
(43) Pub. Date: Jun. 4, 2015

(54) METHOD AND SYSTEM FOR PHOTOGRAPHING MOVING IMAGE FOR SPILL OBSERVATION OF CARBON DIOXIDE IN DEEP PART OF SEA FLOOR

(71) Applicant: KOREA INSTITUTE OF GEOSCIENCE AND MINERAL RESOURCES, Daejeon (KR)

(72) Inventors: Jeong-Chan KIM, Daejeon (KR); Ki-Sung SUNG, Incheon (KR); Kwon-Gyu PARK, Daejeon (KR); Young-Jae SHINN, Daejeon (KR)

(21) Appl. No.: 14/557,122

(22) Filed: Dec. 1, 2014

(30) Foreign Application Priority Data
Dec. 2, 2013 (KR) 10-2013-0148572

(51) Int. Cl. G01N 21/94; H04N 5/225

(52) U.S. Cl. CPC G01N 21/94; H04N 5/225; H04N 2005/2255

(57) ABSTRACT

Disclosed are a method and a system for photographing a moving image for a spill observation of carbon dioxide in a deep part of a sea floor, the system including: a mother boat; a wire connected to the mother boat; and a sea floor carbon dioxide photograph unit connected to the wire to move in a deep part of a sea floor according to a movement of the mother boat and continuously photograph a moving image of the deep part of the sea floor to observe a spill and movement of carbon dioxide generated in the deep part of the sea floor and a method of taking a moving image for a spill observation of carbon dioxide in a deep part of a sea floor using the same.

### CROSS-REFERENCE TO RELATED APPLICATION

This application claims the benefit under 35 U.S.C. §119 of Korean Patent Application No. 10-2013-0148572 filed on Dec. 2, 2013 in the Korean Intellectual Property Office, the entirety of which disclosure is incorporated herein by reference.

### BACKGROUND OF THE INVENTION

1. Field of the Invention

The present invention relates to a method and a system for photographing a moving image for a spill observation of carbon dioxide in a deep part of a sea floor, more particularly, to a system and a method for photographing a moving image in a deep part of a sea floor having at least a predetermined depth, observing whether carbon dioxide is spilled in the deep part of the sea floor, and continuously photographing a moving image of a carbon dioxide movement in the deep part of the sea floor.

2. Description of the Related Art

In general, carbon dioxide (CO₂) is one of the greenhouse gases. If concentration of the carbon dioxide in the atmosphere increases, an atmosphere temperature of earth becomes higher, and on the contrary, the atmosphere temperature becomes lower when the concentration of the carbon dioxide decreases. In addition, the carbon dioxide readily dissolves in sea water and precipitates and accumulates to a predetermined depth.

When a pressure (partial pressure) of the carbon dioxide in the atmosphere is higher than the pressure of the carbon dioxide in the sea water, the carbon dioxide dissolves in the sea water, and on the contrary, when the pressure of the carbon dioxide in the sea water is higher, the carbon dioxide is discharged to the atmosphere.

This designates the circulation activity of the earth crest such as the formation of submarine ridges, and the crest, in which the carbon dioxide is precipitated, is drawn into the earth and discharged back out through volcanic activities or underwater volcanoes, in which the carbon dioxide is discharged in the form of a gas and is dissolved in the sea water and plays the role of increasing the pressure of the carbon dioxide in the sea water.

The pressure of the carbon dioxide in the sea is maintained by this circulation activity of the earth crest, and the amount of the carbon dioxide may be balanced between the atmosphere and the sea.

That is, the carbon dioxide exists in the sea water, and sometimes the carbon dioxide in the atmosphere dissolves into the sea by the circulation activity of the earth crest as described above, and the carbon dioxide may be created from breaths of marine lives.

As such, the movement of the carbon dioxide can be usefully applied for investigating and researching the circulation activity of the earth crest, especially, the present invention provides a technology to photograph a moving image to observe the movement and an outflow of the carbon dioxide generated in a deep part of a sea floor.

In addition, the technology can be usefully applied to a geological exploration and investigation for an underwater drilling hole.

Meanwhile, regarding related arts, the technology for continuously photographing the moving image to observe the carbon dioxide generated in the deep part of the sea floor is rarely found, and the related art denoted below discloses the configuration of a carbon dioxide behavior monitoring system and a method thereof, in which carbon dioxide gas is injected into water mixed with indicator for measuring pH and the water is digitally imaged, thereby accurately measuring a localized pH of a carbonated water, in which carbon dioxide is dissolved, through a non-contact scheme and obtaining quantified information of status variations including a carbon dioxide behavior.

As related arts, there is Korean Registered Patent No. 10-1225508 (Published on Jan. 23, 2013) (invention title: Carbon Dioxide Behavior Monitoring System and Method)

### SUMMARY OF THE INVENTION

An object of an embodiment of the present invention is to provide a method and a system for photographing a moving image for a spill observation of carbon dioxide in a deep part of a sea floor, which can be used in a deep part of a sea floor at a depth of 6,000 to 7,000 m for photographing a moving image to observe if carbon dioxide is spilled in the deep part of the sea floor, and to continuously photograph a moving image of a carbon dioxide movement in a very deep part of the sea floor.

Another object of an embodiment of the present invention is to provide a method and a system for photographing a moving image for a spill observation of carbon dioxide in a deep part of a sea floor, which can effectively photograph the very deep part of the sea floor, can continuously photograph a movement of the carbon dioxide generated in the deep part of the sea floor to observe a spill of the carbon dioxide in the very deep part of the sea floor, and can be usefully applied to an investigation and a research of the circulation activity of the earth crest as well as a geological exploration and an investigation for an underwater drilling hole.

Yet another object of an embodiment of the present invention is to provide a method and a system for photographing a moving image for a spill observation of carbon dioxide in a deep part of a sea floor for improving an efficiency of observing the spill or continuously photographing the movement of the carbon dioxide generated in the deep part of the sea floor.

Objects of the present invention may not be limited to the above objects, and other objects will be clearly understandable to those of ordinary skill in the art from the disclosures provided below.

To solve the object described above, a system for photographing a moving image for a spill observation of carbon dioxide in a deep part of a sea floor according to an embodiment of the present invention includes: a mother boat; a wire connected to the mother boat; and an underwater carbon dioxide photograph unit connected to the wire to move in a deep part of a sea floor according to a movement of the mother boat and continuously photograph the moving image of the deep part of the sea floor to observe a spill and movement of the carbon dioxide generated in the deep part of the sea floor.

In addition, the sea floor carbon dioxide photograph unit may include: a spherical body including an upper part and a lower part, which are evenly divided and coupled to each other; a spherical body comprising an upper part and a lower part, which are evenly divided and coupled to each other; at least one carbon dioxide detection sensor mounted on the body to detect the carbon dioxide in the deep part of the sea floor; at least one camera installed in one of the upper part and the lower part of the body; a lamp provided adjacent to the camera; a water depth measurement device mounted on one of the upper part and the lower part of the body; and a communication unit to transmit at least one of a detection signal from the carbon dioxide detection sensor, an image signal of the moving image obtained from the camera and a measurement signal from the water depth measurement device to the mother boat and to receive a control signal to control the camera from the mother boat.

In this case, a weight may be accommodated or suspended in a lower portion of the body to maintain a center of gravity and balance of the body.

In addition, a weight may be mounted on an outer surface of both sides of the body to maintain a center of gravity and balance of the body.

In addition, a plurality of cameras may be radially arranged.

Preferably, the camera may be an infrared camera.

Preferably, the water depth measurement device may be an echo sounder or a pressure gauge.

Further, power source may further be included to supply power to the carbon dioxide detection sensor, the camera, the lamp, the water depth measurement device and the communication unit.

Preferably, the body may include a transparent part having a light transmittance.

Meanwhile, to solve the object, a method for photographing a moving image for a spill observation of carbon dioxide in a deep part of a sea floor according an embodiment of the present invention includes: (A) introducing an underwater carbon dioxide photograph unit connected to a mother boat into the deep part of the sea floor; (B) photographing a moving image of the deep part of the sea floor through a camera provided on the underwater carbon dioxide photograph unit; (C) continuously photographing the moving image of the deep part of the sea floor by moving the underwater carbon dioxide photograph unit introduced into the deep part of the sea floor while moving the mother boat; (D) identifying if a carbon dioxide detection signal is generated from a carbon dioxide sensor when photographing the moving image of the deep part of the sea floor; (E) continuously photographing the moving image of a carbon dioxide generation area and a neighboring area of the carbon dioxide generation area of the deep part of the sea floor when the carbon dioxide detection signal is generated from the carbon dioxide detection sensor; and (F) storing the photographed image obtained through steps of (B), (C) and (E) in the carbon dioxide photograph unit and simultaneously transmitting the photographed image to the mother boat.

In this case, the photographing of the moving image in steps (B), (C), and (E) includes: simultaneously photographing the moving image of the deep part of the sea floor in multiple directions through a plurality of cameras radially arranged.

Detailed descriptions of other embodiments are included in the detailed descriptions and the accompanying figures.

Advantages and features of the present invention, and method for achieving thereof will be apparent with reference to the examples that follow. But, it should be understood that the present invention is not limited to the following embodiments and may be embodied in different ways, and that the embodiments are given to provide complete disclosure of the invention and to provide thorough understanding of the invention to those skilled in the art, and the scope of the invention is limited only by the accompanying claims and equivalents thereof.

According to an embodiment of the present invention, a photographing position of an underwater carbon dioxide photograph unit introduced into a deep part of a sea floor may be varied according to a position of a mother boat, and the underwater carbon dioxide photograph unit including a spherical body may be easily introduced into the deep part of the sea floor and a moving image of the deep part of the sea floor having a depth of 6,000 to 7,000 m may be continuously photographed through a camera provided on the underwater carbon dioxide photograph unit and the image may be transmitted to the mother boat in real-time so that whether a carbon dioxide is spilled in a deep part of the sea floor and a movement of the carbon dioxide generated in the deep part of the sea floor may be easily observed from the mother boat.

An embodiment of the present invention may simultaneously photograph the moving image in multiple directions of the deep part of the sea floor having the depth of 6,000 to 7,000 m, and the efficiency can be improved when observing the spill or continuously photographing the carbon dioxide generated in a very deep part of the sea floor.

An embodiment of the present invention may observe the movement of the carbon dioxide generated in the deep part of the sea floor, may predict changes in physical properties in the deep part of the sea floor having the depth of 6,000 to 7,000 m, and may be usefully applied to understand an underwater geological structure.

### BRIEF DESCRIPTION OF THE DRAWINGS

FIG. 1 is a schematic view illustrating a system for photographing a moving image for a spill observation of carbon dioxide in a deep part of a sea floor according to an exemplary embodiment of the present invention.

FIG. 2 is a block diagram illustrating the system for photographing a moving image for a spill observation of carbon dioxide in a deep part of a sea floor according to an exemplary embodiment of the present invention.

FIG. 3 is a perspective view to explain an underwater carbon dioxide photograph unit according to an embodiment of the present invention.

FIG. 4 is a perspective view illustrating a separated state of a body of the underwater carbon dioxide photograph unit according to an embodiment of the present invention.

FIG. 5 is a block diagram to explain a signal system between components of the system for photographing a moving image for a spill observation of carbon dioxide in a deep part of a sea floor according to an embodiment of the present invention.

FIG. 6 is an exemplary view to explain a center of gravity and a balance of the underwater carbon dioxide photograph unit according to an embodiment of the present invention.

FIG. 7 is another exemplary view to explain a center of gravity and a balance of the underwater carbon dioxide photograph unit according to an embodiment of the present invention.

FIG. 8 is a view illustrating an example of a camera installation according to an embodiment of the present invention.

FIG. 9 is a view illustrating another example of a camera installation according to an embodiment of the present invention.

FIG. 10 is a block diagram illustrating a method for photographing a moving image for a spill observation of carbon dioxide in a deep part of a sea floor according to an exemplary embodiment of the present invention.

### DETAILED DESCRIPTION OF THE INVENTION

Hereinafter, an embodiment of the present invention is described in detail in reference to the accompanying drawings.

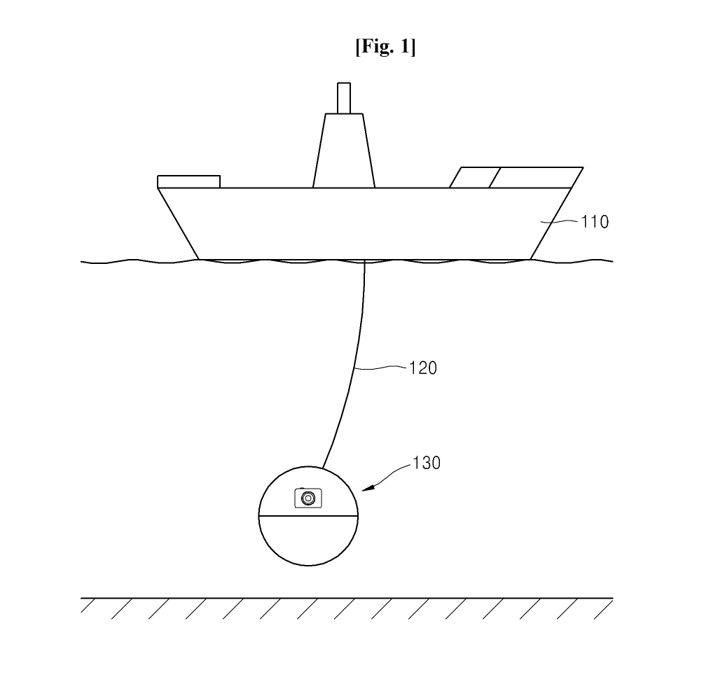

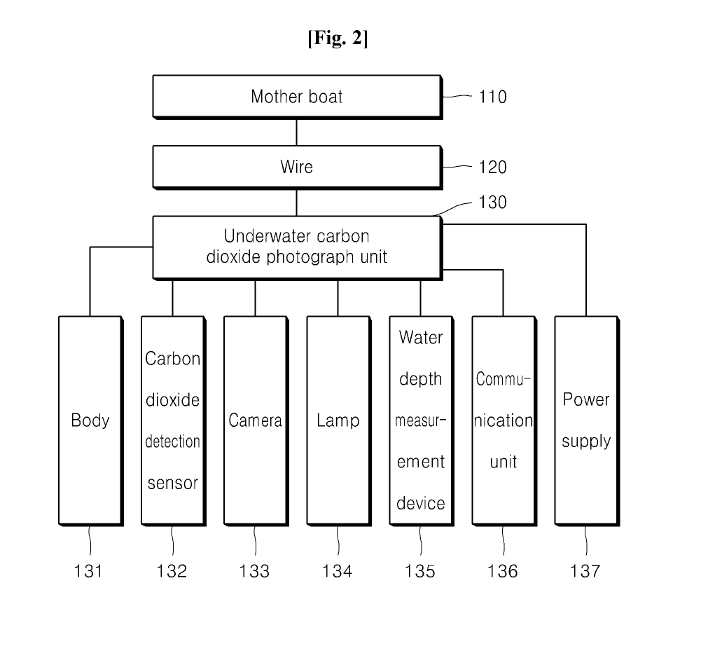

As illustrated in FIG. 1 and FIG. 2, a system for photographing a moving image for a spill observation of carbon dioxide in a deep part of a sea floor according to an embodiment of the present invention, which may be introduced into a deep part of a sea floor having a depth of 6,000 to 7,000 m and withstand a pressure in affect in the deep part of the sea floor, includes: a mother boat 110; a wire 120 connected to the mother boat 110; and an underwater carbon dioxide photograph unit 130 connected to the wire 120 to move in a deep part of a sea floor according to a movement of the mother boat 110 and continuously photograph the moving image of the deep part of the sea floor to observe a spill and movement of the carbon dioxide generated in the deep part of the sea floor.

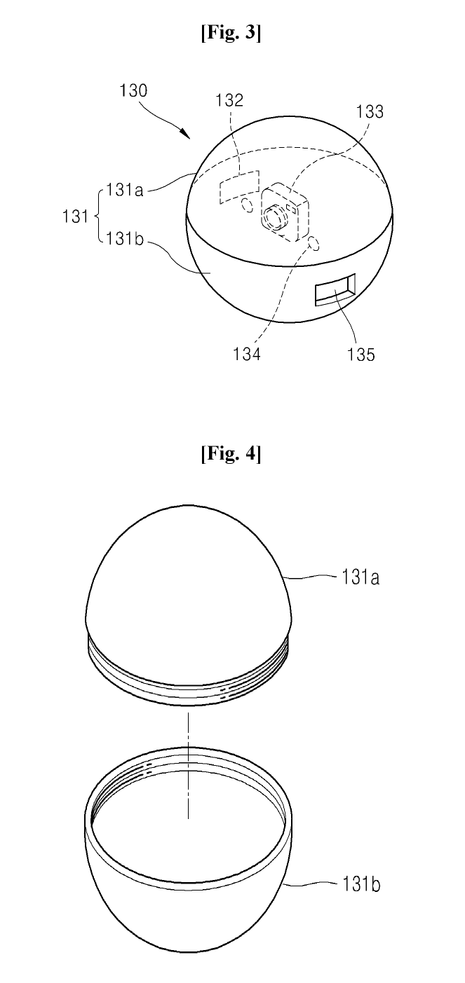

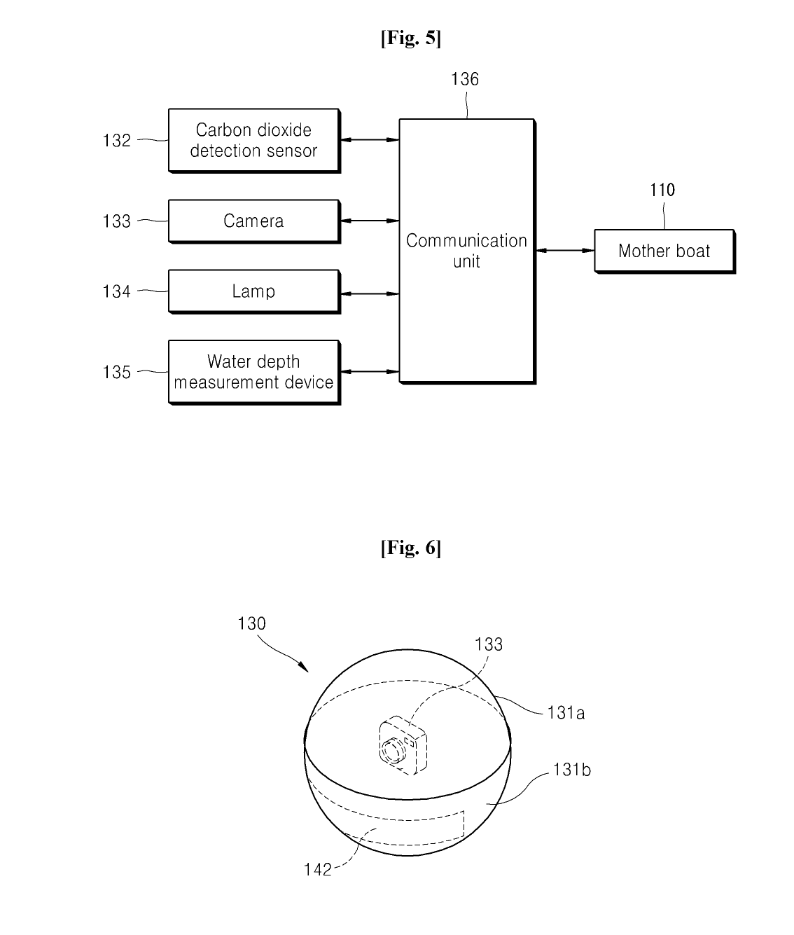

The underwater carbon dioxide photograph unit 130, as illustrated in FIG. 2 to FIG. 9, includes: a spherical body 131 including an upper part 131a and a lower part 131b, which are evenly divided and coupled to each other; at least one carbon dioxide detection sensor 132 mounted on the body 131 to detect the carbon dioxide of the deep part of the sea floor; at least one camera 133 installed in any one of the upper part 131a and the lower part 131b of the body 131; a lamp 134 provided adjacent to the camera 133; a water depth measurement device 135 mounted on one of the upper part 131a and the lower part 131b of the body 131; and a communication unit 136 to transmit at least one of a detection signal from the carbon dioxide detection sensor 132, an image signal of the moving image obtained from the camera 133 and a measurement signal from the water depth measurement device 135 to the mother boat 110 and to receive a control signal to control the camera from the mother boat 110.

In this case, a power source 137 is further included to supply power to the carbon dioxide detection sensor 132, the camera 133, the lamp 134, the water depth measurement device 135 and the communication unit 136.

Preferably, the power source 137 may be a battery provided in the body 131, and may be a power cable connected to the mother boat to receive power from the mother boat 110.

Preferably, the underwater carbon dioxide unit 130 may be provided inside the mother boat 110 along with the wire 120 and configured to be introduced and used in the sea floor as necessary.

In this case, a frame or a bracket (not illustrated) may be provided in the body 131, that is, in the upper part 131a and the lower part 131b to easily and fixedly install components such as the camera 133, the lamp 134, the water depth measurement device 135 and the communication unit 136.

The upper part 131a and the lower part 131 of the body have a separator structure, that is, a male-female coupling structure corresponding to each other, and preferably have a sealing property and a water resistance. An O-ring may be used in the coupling part.

On the lower part 131b of the body 131, as illustrated in FIG. 6, a weight 142 is preferably accommodated and suspended on the body to maintain a center of gravity and balance of the carbon dioxide photograph unit 130.

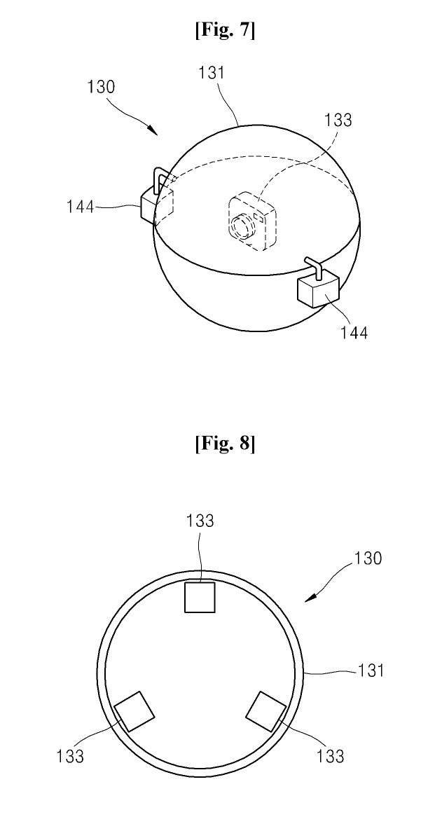

In addition, as illustrated in FIG. 7, weights 144 having equivalent weights may be mounted on an outer surface of both sides of the body 131 to maintain the center of gravity and balance of the body.

As can be observed from the described example, the carbon dioxide photograph unit 130 may be more easily introduced and installed in the deep part of the sea floor having the depth of 6,000 to 7,000 m through the configuration of the weights 142 and 144, and the moving image in the very deep part of the sea floor may be more easily photographed by maintaining the center of gravity and balance of the carbon dioxide photograph unit 130 through the structural coupling.

That is, the weights are for maintaining the center of gravity and balance so that the upper part 131a is always at an upper side even when disposed in the deep part of the sea floor to prevent a sloshing effect, in which the camera 133 tilts to any one direction, from occurring.

In addition, the lower part 131b itself maybe configured as a weight.

Further, the body 131 may be configured to maintain the center of gravity by mounting a sensor such as a gyro sensor.

The body 131, as illustrated, is preferably configured in a spherical shape to withstand a pressure in affect in the very deep part of the sea floor and easily move by minimizing a resistance according to a movement in the deep part of the sea floor having the depth of 6,000 to 7,000 m.

The body 131 includes a transparent part having light transmittance to easily photograph the moving image through accommodating the camera 133.

For example, the body 131 may be configured to have a spherical pressure vessel shape to withstand the pressure such as a water pressure in affect in the deep part of the sea floor, in which the transparent part having the light transmittance is provided at a front of the camera 133.

The carbon dioxide detection sensor 131 is mounted on the body 131 in such a manner that the carbon dioxide detection sensor 131 is exposed to an exterior of the body, and multiple carbon dioxide detection sensors are preferably installed to improve a carbon dioxide detection efficiency in the deep part of the sea floor.

The camera 133 may be installed inside anyone of the upper part 131a and the lower part 131b of the body 131, but it is more preferable to install the camera 133 in the upper part 131a, and to arrange plural cameras to cover multiple directions as possible for cardinal points of north, south, east and west.

The efficiency of observing the carbon dioxide spill can be improved because the moving image in the deep part of the sea floor may be simultaneously photographed in multiple directions through the multiple camera arrangement.

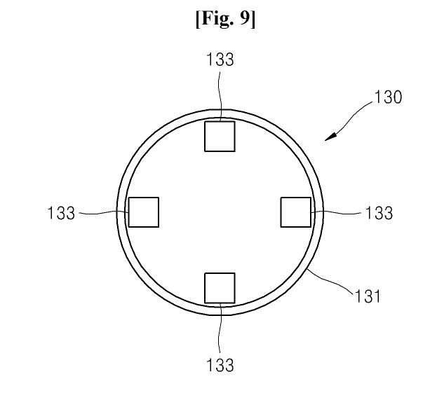

In this case, a plurality of the cameras 133 maybe provided, which are radially arranged with respect to a circumferential direction, and the cameras 133 may be arranged in various arrangements such as three cameras arranged in a triangular shape as illustrated in FIG. 8, or sometimes four cameras arranged in a quadrangular shape as illustrated in FIG. 9,

In addition, the camera 133 preferably uses an infrared camera to obtain a sharp image and realize discrimination by taking into consideration darkness in the deep part of the sea floor.

The lamp 134 is for lighting a surrounding of the camera 133 to further enhance a resolution of the photographing of the moving image, and an LED is preferable for the lamp 134.

The lamp 134 is provided in a number corresponding to the number of the cameras 133.

The water depth measurement device 135 is for measuring the depth of the deep part of the sea floor, and for designating and identifying a location, to which the underwater carbon dioxide photograph unit 130 is introduced, and may include an echo sounder to measure the water depth by using a sound wave, or a pressure gauge to measure the water depth by using the pressure in affect in the deep part of the sea floor.

In this case, the water depth measurement device 135 is installed inside the body 131 or on the body, and the water depth measurement device 135 may be installed to be exposed to an exterior of the body.

The communication unit 135 may be configured as a wired scheme of a wireless scheme.

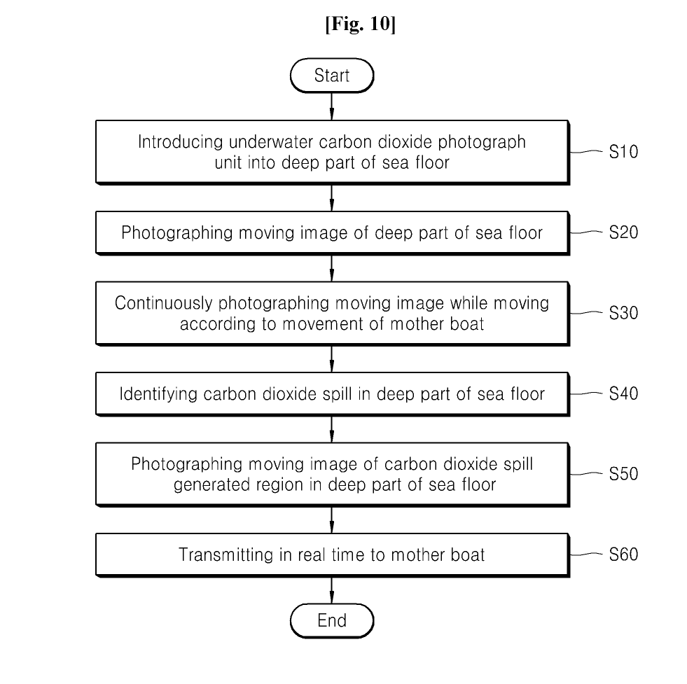

Meanwhile, FIG. 10 is a block diagram illustrating a method for photographing a moving image for a spill observation of carbon dioxide in a deep part of a sea floor according to an exemplary embodiment of the present invention, and the method uses the system for photographing a moving image for a spill observation of carbon dioxide in a deep part of a sea floor configured as described above.

As illustrated in FIG. 10, the underwater carbon dioxide photograph unit 130 connected to the mother boat 110 through the wire 120 is introduced into a deep part of a sea floor having the depth of 6,000 to 7,000 m S10.

In this case, the mother boat 110 identifies the water depth through the signal from the water depth measurement device 135, which is provided and operated on the underwater carbon dioxide photograph unit 130, to introduce the underwater carbon dioxide photograph unit 130 to a desired location in the deep part of the sea floor.

After the underwater carbon dioxide photograph unit 130 connected to the mother boat 110 is introduced into the deep part of the sea floor, the moving image of the deep part of the sea floor having the depth of 6,000 to 7,000 m is photographed by operating the camera 133 through transmitting a drive signal to the camera 133 provided on the underwater carbon dioxide photograph unit 130 S20.

In this case, the lamp 134 is controlled so that the lamp 134 provides light when photographing the moving image in the deep part of the sea floor through the camera 133.

And then, for photographing the moving image of the deep part of the sea floor using the camera 133, the moving image of the deep part of the sea floor is continuously photographed by moving the underwater carbon dioxide photograph unit 130 introduced into the deep part of the sea floor through moving the mother boat 110 S30.

In this case, the underwater carbon dioxide photograph unit 130 is guided and moved in the deep part of the sea floor having the depth of 6,000 to 7,000 m according to the movement of the mother boat 110 while connecting to the mother boat 110 through the wire 120.

The mother boat 110 identifies whether a detection signal with respect to the carbon dioxide generated in the deep part of the see floor is generated from the carbon dioxide sensor 132 when photographing the moving image in the deep part of the sea floor though the camera 133 provided on the underwater carbon dioxide photograph unit 130 S40.

The mother boat 110, which is temporarily stopped, continuously and concentratedly photographs the moving image of a carbon dioxide generated area and a neighboring area of the carbon dioxide generated area of the deep part of the sea floor where the carbon dioxide is detected when the carbon dioxide detection signal is generated by the carbon dioxide detection sensor 132 S50.

In this case, the mother boat 110 determines an amount of the photographing of the moving image according to a concentration of the detected carbon dioxide, and an amount of the spill or the movement of the carbon dioxide generated in the deep part of the sea floor is observed.

In addition, the circulation activity of the earth crest and an underwater geological status may be identified through photographed moving image data of the carbon dioxide generated area and the neighboring area of the carbon dioxide generated area of the deep part of the sea floor.

The moving image continuously photographed through steps of S20, S30 and S50 is stored in the underwater carbon dioxide photograph unit 130 and simultaneously transmitted to the mother boat 110 in real-time through the communication unit 136 S60.

When multiple cameras 133 are radially arranged in the underwater carbon dioxide photograph unit 130, the efficiency of photographing the moving image of the deep part of the sea floor can be improved because the moving image is simultaneously photographed in multiple directions in the deep part of the sea floor.

Therefore, the present invention provides a system and a method for varying the photographing position of the underwater carbon dioxide photograph unit 130 introduced into the deep part of the sea floor having a depth of at least a predetermined depth according to the location of the mother boat 110, which can continuously photograph the moving image of the deep part of the sea floor through the camera 133 in the underwater carbon dioxide photograph unit 130 and transmit the moving image in real-time to the mother boat 110 so that whether the carbon dioxide is spilled in the very deep part of the sea floor and the movement of the carbon dioxide generated in the deep part of the sea floor may be observed through monitoring the moving image in the mother boat 110.

While the present invention has been particularly shown and described with reference to various embodiments thereof, it should be understood that the descriptions are only examples and should not be interpreted in any way to limit the scope of the present invention, and it will be understood by those of ordinary skill in the art that various substitutions, changes in form and alterations may be made therein without departing from the spirit and the scope of the present invention.

What is claimed is:

1. A system for photographing a moving image for a spill observation of carbon dioxide in a deep part of a sea floor, the system comprising:
a mother boat;
a wire connected to the mother boat; and
an underwater carbon dioxide photograph unit connected to the wire to move in a deep part of a sea floor according to a movement of the mother boat and continuously photograph the moving image of the deep part of the sea floor to observe a spill and movement of the carbon dioxide generated in the deep part of the sea floor.

2. The system according to claim 1, wherein the underwater carbon dioxide photograph unit comprises:
a spherical body comprising an upper part and a lower part, which are evenly divided and coupled to each other;
at least one carbon dioxide detection sensor mounted on the body to detect the carbon dioxide in the deep part of the sea floor;
at least one camera installed in one of the upper part and the lower part of the body;
a lamp provided adjacent to the camera;
a water depth measurement device mounted on one of the upper part and the lower part of the body; and
a communication unit to transmit at least one of a detection signal from the carbon dioxide detection sensor, an image signal of the moving image obtained from the camera and a measurement signal from the water depth measurement device to the mother boat and to receive a control signal to control the camera from the mother boat.

3. The system according to claim 2, wherein a weight is accommodated or suspended in a lower portion of the body to maintain a center of gravity and balance of the body.

4. The system according to claim 2, wherein a weight is mounted on an outer surface of both sides of the body to maintain a center of gravity and balance of the body.

5. The system according to claim 2, wherein a plurality of cameras are radially arranged.

6. The system according to claim 2, wherein the camera is an infrared camera.

7. The system according to claim 2, wherein the water depth measurement device is an echo sounder or a pressure gauge.

8. The system according to claim 2, further comprising a power source to supply power to the carbon dioxide detection sensor, the camera, the lamp, the water depth measurement device and the communication unit.

9. The system according to claim 2, wherein the body comprises a transparent part having a light transmittance.

10. A method of photographing a moving image for a spill observation of carbon dioxide in a deep part of a sea floor, the method comprising:
(A) introducing an underwater carbon dioxide photograph unit connected to a mother boat into the deep part of the sea floor;
(B) photographing a moving image of the deep part of the sea floor through a camera provided on the underwater carbon dioxide photograph unit;
(C) continuously photographing the moving image of the deep part of the sea floor by moving the underwater carbon dioxide photograph unit introduced into the deep part of the sea floor while moving the mother boat;
(D) identifying if a carbon dioxide detection signal is generated from a carbon dioxide sensor when photographing the moving image of the deep part of the sea floor;
(E) continuously photographing the moving image of a carbon dioxide generation area and a neighboring area of the carbon dioxide generation area of the deep part of the sea floor when the carbon dioxide detection signal is generated from the carbon dioxide detection sensor; and
(F) storing the photographed image obtained through steps of (B), (C) and (E) in the carbon dioxide photograph unit and simultaneously transmitting the photographed image to the mother boat.

11. The method according to claim 10, wherein
the photographing of the moving image in steps (B), (C), and (E) comprises:
simultaneously photographing the moving image of the deep part of the sea floor in multiple directions through a plurality of cameras radially arranged.
